(19) United States
(12) Patent Application Publication
(10) Pub. No.: US 2005/0136280 A1
(43) Pub. Date: Jun. 23, 2005

(54) Fiber brushes free of circulatory currents

(75) Inventor: Doris Kuhlmann-Wilsdorf, Charlottesville, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: HIPERCON, LLC, Arlington, VA (US)

(21) Appl. No.: 10/998,045

(22) Filed: Nov. 29, 2004

Related U.S. Application Data
(60) Provisional application No. 60/525,850, filed on Dec. 1, 2003.

(51) Int. Cl. H01R 39/00; H02K 1/00; H01R 39/08

(52) U.S. Cl. 428/611; 310/251; 310/252; 29/826; 439/13

(57) ABSTRACT

A metal fiber or monolithic brush for suppressing circulatory currents includes a base plate that includes plural conductive portions separated by plural current flow barriers oriented normal to the plane of the anticipated circulatory current loops. In the case of a metal fiber brush, the metal fibers are provided with electrically insulating surface films, in the case of a monolithic brush, the brush body is provided with current barriers oriented normal to the plane of the anticipated circulatory current loops. The conductor to which the base plate is electrically connected as well as the substrate on which the brush slides can also be provided with current flow barriers oriented normal to the plane of the anticipated circulatory current loops.

### CROSS REFERENCE TO RELATED APPLICATION

This application is related in subject matter to U.S. Pat. No. 6,245,440, the disclosure of which is incorporated by reference herein in its entirety.

### BACKGROUND OF THE INVENTION

1. Field of the Invention

The present invention relates to a metal fiber brush and attached base plate configured to conduct current while penetrated by a magnetic field.

2. Discussion of the Related Art and Problem to be Solved

A metal fiber brush comprises a fibrous part of substantially parallel metal fibers that on one end are conductively, permanently fastened to a metal base plate and whose free ends are collectively shaped to conform to a “substrate”. The purpose of a metal fiber brush is to conduct current between a substrate and a conductor to which the base plate is mechanically, conductively fastened. Typically but not necessarily, the conductor to which the base plate is fastened is in relative motion to the substrate.

Known substrates include a commutator of a direct current (DC) generator or motor, and a slip ring of an alternating current (AC) generator or motor, and the base plate is fastened to the stator. By this arrangement, current is conducted from the slip ring or commutator through the multiple conductive fibers and the base plate of the conventional metal fiber brush to the stator to which the base plate is rigidly, electrically conductively connected, such that operation of the generator or motor can be maintained.

This machine operation may be significantly impaired by an extraneous magnetic field, meaning a magnetic field that originates outside of the metal fiber brush, i.e. is not due to the current flowing through the brush. This is so because an extraneous magnetic field, firstly, exerts a Lorentz force on the current in the brush, thereby causing the corresponding extraneous mechanical force on the brush that can on occasion become so strong as to bend or mechanically crush the metal fiber brush. Secondly, an extraneous magnetic field can cause a circulating current of significant strength in or through the brush, meaning a current loop that is closed in itself. Thus a circulatory current may enter a brush from, say, the substrate on one side of the brush and return to the substrate on the other side of the brush, or similarly it may enter a brush through the base plate on one side and leave it through the base plate on the other side.

To the degree that the fibrous part of the brush is electrically conductive as a result of electrically conductive points of mechanical contact among neighboring fibers, the path of the circulatory current may be completed in the fibrous part of the brush. Additionally or alternatively the circulatory current path may be completed within the base plate, or it may be completed in the substrate or in the machine part to which the base plate is rigidly, electrically conductively connected.

According to the present invention, in all of the named cases, circulatory currents on account of extraneous magnetic fields are inhibited in the fibrous part of a metal fiber brush by providing a high electrical resistance between neighboring fibers through supplying a thin insulating layer on the substantial majority of the fibers over most of their length, and are inhibited in solid metal parts such as base plates, stators, slip rings and commutators, by supplying two-dimensional current flow barriers that are parallel to the intended current but normal to the plane of the circulatory current loops.

Supplying two-dimensional current flow barriers in at least part of a stator and in the metal of the substrate is required for the complete suppression or at the least weakening of circulatory currents due to extraneous magnetic fields because inhibiting the completion of the circulatory current in the fibrous part of the brush and/or in the base plate, will still permit circulatory currents between, say, the substrate and the stator by means of current flow in opposite directions through different parts of a brush.

Even if circulatory currents are completely suppressed by means of the described current flow barriers normal to the plane of the circulatory current loops, a magnetic field penetrating a brush on a moving substrate will generate eddy currents within the individual fibers and within the base plate. However, current strength and energy loss through such eddy currents, i.e. small-scale circulating currents, will be negligible. By contrast the current strength of the discussed circulatory currents on the scale of metal fiber brushes (and similarly under the same conditions also in monolithic graphite or metal-graphite brushes) can become large. For example, in the superconducting homopolar motor presently under construction at General Atomics Inc. in San Diego, Calif., the discussed circulatory currents are forecast to attain the strength of hundreds of ampere per square centimeter, and thus to be much larger than the intended currents through the brushes. As a result one half of a brush will experience a much larger current than intended, while the other half will carry a net current in the opposite direction than intended.

The production of metal fiber brushes with base plates including multiple current flow barriers normal to the plane of circulatory current loops is believed to be unproblematic. Most directly, strips of metal of the intended thickness and width of the base plate may be glued together and the fibrous part of the brush be conductively attached thereto, using proven methods and materials, e.g. soldering. Or for production of larger numbers of brushes, metal sheet or plates of the desired thickness of the base plates may be glued together in a stack by means of epoxy or other adhesive, and then be cut into base plates normal to the plane of the sheets or plates in the stack. Again, metal fibers may be attached to such base plates in the usual manner. Finally, the same method may be used also in case not metal fiber brushes but monolithic brushes are used, except that in these, circulatory currents inside of the brush body would have to be suppressed by different means, e.g. by slicing the brush body into a plurality of slices and gluing them together with an insulative adhesive, such as an epoxy, a ceramic cement, stop-off lacquer or other.

In the case of existing brushes on base plates, the desired current flow barriers cannot be introduced through the entire thickness of the base plate and adhesive or solder layer because in the step of cutting the base plate, an already existing metal fiber brush will fall apart. Therefore, for the purpose of retrofitting, partial cuts may be made through the base plate, from the side away from the fibrous brush part and stopping short of complete mechanical separation of the base plate. The cuts, or “grooves” resulting from such partial cuts may then be filled with epoxy or other adhesive so as to provide mechanical strength after curing the adhesive.

### BRIEF SUMMARY OF THE INVENTION

Accordingly, it is an object of the present invention to inhibit the completion of circulatory currents in metal fiber brushes configured to conduct current between two conductors in at rest of in relative motion such as the stator and commutator or a slip ring of an electric machine. Another object of the present invention is to inhibit circulatory currents entirely by blocking current flow lines in the conductors between which metal fiber brushes, or indeed any kind of brush, conduct current.

These and/or other objects of the invention can be provided by the present invention by means of current flow barriers that consist of thin layers of insulating material parallel to the intended current direction but normal to the plane of circulatory current loops. Specifically, according to the present invention a metal fiber brush suppresses the completion of circulatory currents in its fibrous part by insulating layers on the individual fibers, and a base plate suppresses the completion of circulatory currents by including plural conductive portions mutually separated by insulative layers that are oriented normal to the plane of the circulatory current loop.

The present invention still further provides a brush for partially suppressing the completion of circulatory currents in its base plate by including a base plate having plural conductive portions separated by plural grooves disposed in the base portion. An insulative material is disposed in the grooves.

The present invention still further provides a method of manufacturing a metal fiber brush, including disposing plural insulative portions between conductive portions to form a base plate, and attaching multiple conductive fibers to the base.

The present invention still further provides a method of electrically suppressing the completion of a circulatory current in a base plate of a brush configured to conduct current from a substrate to a machine part in relative motion to the substrate including dividing the base into a plurality of conductive portions, and disposing an insulative portion between the conductive portions.

The present invention still further provides for a method of electrically suppressing or weakening a circulatory current by providing current flow barriers in the substrate on which a metal fiber brush slides.

The present invention still further provides for a method of electrically suppressing or weakening a circulatory current by providing current flow barriers in the metal to which the base plate is mechanically, electrically conductively fastened, such as the stator of an electrical machine.

### BRIEF SUMMARY OF THE DRAWINGS

A more complete appreciation of the invention and many of the attendant advantages thereof will be readily ascertained and/or obtained as the same becomes better understood by reference to the following detailed description when considered in view of the accompanying drawings, wherein:

FIG. 1 shows an isometric view of a metal fiber brush including a base plate and a substrate that include plural conductive portions separated by insulative portions that are oriented parallel to the direction of relative motion, and a circular arrow indicating a loop of the circulatory current oriented normal to the direction of the relative motion that is inhibited by the insulative portions according to an embodiment of the invention.

FIG. 2 shows an isometric view of a metal fiber brush member including a base plate and substrate that include plural conductive portions separated by insulative portions that are oriented normal to the direction of relative motion, and a circular arrow indicating a loop of the circulatory current oriented parallel to the relative motion that is inhibited by the insulative portions according to another embodiment of the invention.

### DESCRIPTION OF THE PREFERRED EMBODIMENTS

Examples of preferred embodiments of the present invention are described with reference to the drawings, wherein like reference numbers identify like and/or similar elements.

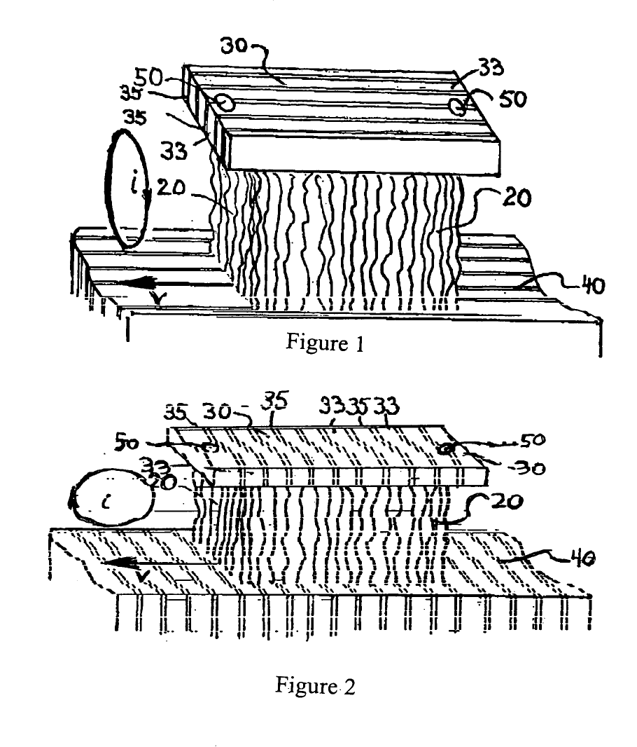

FIGS. 1 and 2 show specific examples of preferred embodiments of the current flow barriers, and more particularly show specific examples of preferred embodiments of the current flow barriers in the base plate and the substrate. The figures show a metal fiber brush whose brush body 20 is composed of multiple conductive fibers attached to the base plate 30. The brush fibrous part 20 of the brush is configured to conduct current from a conductor (not shown) to which the base plate is mechanically, electrically conductively connected, to a substrate 40, moving with velocity v as indicated (which may include v =0 and either sense of direction).

Alternatively, the brushes depicted in FIGS. 1 and 2 could be monolithic with a brush body 20 made of one or more of graphite, metal-graphite, and/or metals in which case current flow barriers of the same orientation as elsewhere are present in the form of insulative layers of adhesives. The brush body 20 can be attached to the base plate by a layer of solder or any other suitable conductive material. The substrate 40 can include a rotating member, such as a commutator of a direct current (DC) motor or generator, and a slip ring of an alternating current (AC) motor or generator. Detailed descriptions of characteristics of the multiple conductive fibers 20 of metal fiber brushes can be ascertained from the above-referenced patent, which has been incorporated by reference herein in its entirety. Thus, although the drawings show certain preferred embodiments of the multiple conductive fibers 20 and the substrate 40, it is to be understood that the multiple conductive fibers 20 and the substrate 40 can be of various types, and that a solid body of a monolithic brush supplied with current flow barriers can be substituted for a fibrous part of a metal fiber brush. In preferred embodiments, the present invention can be implemented in conjunction with U.S. Pat. No. 6,245,440, the entire contents of which has been incorporated by reference herein.

For the case of metal fiber brushes, the fibers in the fibrous parts 20 in FIGS. 1 and 2 are understood to be provided with thin insulating surface layers that inhibit all significant current conduction except along the metal fibers, to the effect that circulatory current loops cannot be closed in fibrous parts 20. Further, in FIG. 1 the base plate 30 is provided with insulating current flow barriers 35 that in fact will generally be much thinner than indicated in the drawing. Current flow barriers 35 separate conductive portions 33 and are oriented to suppress circulatory current loops that are normal to the direction of motion, i.e. are normal to vector v, as indicated by the arrowed loop marked “i” at left.

In FIGS. 1 and 2 the substrate 40, i.e. the metal underlying the interface with which the metal fiber ends make electrical contact, is provided with the same or similar current flow barriers as in base plate 30. While in FIG. 1 the orientation of the current flow barriers is parallel to the sliding velocity vector in FIG. 1, it is normal to v in FIG. 2, in accordance with the different orientation of the circulatory current loops to be suppressed as indicated by the arrowed loops labeled “i”, namely normal to the direction of relative motion that is indicated by the arrow labeled v in FIG. 1 and parallel to the direction of relative motion in FIG. 2. Correspondingly, the current flow barriers in FIGS. 1 and 2 are parallel and normal to the sliding direction, respectively, both in the base plate and the substrate, and they shall have the same orientation in the stator or to whichever conductor the base plate is fastened but that are not shown in FIGS. 1 and 2.

It is to be understood that the statement “the conductive portions” as used herein is understood to include at least two conductive portions, but not be limited to two conductive portions, and the statement “current flow barriers” is understood to include at least one insulative layer, but not be limited to one insulative layer. In a preferred embodiment of the invention, the base plate 30 includes a multiplicity of conductive portions 33 as well as current flow barriers 35.

As used herein, it is to be understood that the terms “conductive” and “insulating” or “insulative” are relative terms, such that the conductive portions 33 can be configured to conduct current relatively more effectively than the insulative portion 35. In a preferred embodiment of the invention, conductive portions 33 can include a large variety of metals, such as copper, copper alloy, brass, bronze, silver, silver alloy, tin, zinc and others, and/or a material of the insulative current flow barriers 35 can include an adhesive, such as an epoxy, a plastic, a ceramic cement, a rubber or other.

The brush base plate 30 can include a connection configured to achieve a rigid, electrically conductive mechanical connection with the machine part to which current shall be conducted to or from substrate 40 via the brush. As shown in the figures, in a preferred embodiment of the invention, the base plate 30 comprises two screw holes for screwing the base plate on to, say, the stator. Herein the screw should be tightened to the point of adequately low contact resistance between base plate and stator. This may be facilitated by, say, silver-plating the base plate (not shown in the figures). The screw holes 50 can be disposed in the conductive portions 33 and/or the current flow barriers 35.

Manufacture of the brush body 20 of a metal fiber brush with a current channeling property can be achieved by a variety of methods. For example, the fibers can be covered with an insulating surface film either before, during or after assembling the fibrous part, such as through a coating with a polymer or lacquer, or through oxidation of either the fibers directly or a thin plating provided on the fibers. Such oxidation may occur automatically in the atmosphere or may be effected in a controllable manner by heating in oxygen or under access of atmospheric air. Current channeling of monolithic brush bodies is achieved by slicing and rejoining with insulative adhesive in the desired orientation, in line with FIGS. 1 and 2.

Similarly, provision of current flow barriers in a base plate can be accomplished in various ways. Most directly, conductive portions 33 of the base plate can be sized and shaped during one or more operations. The conductive portions 33 can be bonded to one another by the insulative portion 35 to make a base plate. Alternatively, parallel plates or sheets of the material of conductive portions 33 can be glued together with the material of insulative portion 35. From this assembly, base plates in the orientations of FIGS. 1 and 2 can be cut, and the surface to which the fibers shall be attached can be prepared for attaching the fibers, e.g. through soldering or gluing with an electrically conductive adhesive. Thereafter the conductive fibers 20 can be attached, i.e. glued on or soldered.

Still alternatively, the insulative portion 35 can be disposed in a heretofore conventional base of a conventional brush, thereby providing the conductive portions 33 separated by the insulative portion 35. For example, a volume of a conductive material of the conventional base of the conventional brush can be removed, such that one or more grooves are formed on the base. The insulative portion 35 can be provided in the one or more grooves, thereby forming conductive portions 33. It is to be understood that the insulative portion 35 is not required to completely electrically isolate the conductive portions 33 from one another. Rather, satisfactory suppression of circulatory currents may be achieved by disposing the insulative portion 35 to separate some volume of the conductive portions 35 from one another. However, the insulative portion 35 can extend from a top surface of the brush member 30 to a solder or other bonding layer for connection of the multiple conductive fibers 20.

Current flow barriers in the substrate, i.e. the material underlying the brush/substrate interface whether in a slip ring or a commutator or other, and in the material to which the base plate is conductively attached, e.g. the stator of a machine, may be similarly made as narrow, including mechanically with a saw, or a machining tool, or by means of a laser, or spark erosion or water jet machinings made by any suitable means, that are filled in with an insulating material such as a glue, epoxy, ceramic cement or other. The depth to which such current flow barriers need to extend in order to inhibit circulating currents will depend on the morphology of the magnetic field that causes them, and the specific methods to be used in making the barriers will have to be determined from case to case.

For the sake of minimum electrical resistance of a base plate, stator, substrate or other, current flow barriers in any of these should be made as thin as may be possible, e.g. as determined by the width of a fine saw cut, or a groove cut by a laser, or by spark cutting, or made by means of water jet erosion, or any other. The dimensions of the conductive portions between neighboring current flow barriers, by contrast, will typically be made as wide as possible compatible with the need to suppress circulatory current loops. Such dimensions have not as yet been calculated but it is intuitively believed that already four current flow barriers over the width of a base plate in the configuration of FIG. 1 will go a long way towards eliminating circulating currents, and similar spacings also in the substrate and stator, respectively.

Numerous modifications and variations of the present invention are possible in light of the above teachings. It is therefore to be understood that within the scope of the appended claims, the invention may be practiced otherwise than as specifically described herein.

1. A metal fiber brush for suppressing circulatory currents, comprising:
a base plate comprising plural conductive portions separated by at least one electrically insulating current flow barrier, the at least one current flow barrier oriented normal to a plane of an expected circulatory current; and
a fibrous brush body comprising multiple conductive, substantially parallel metal fibers including an electrically insulating surface film, the fibers assembled into a fibrous brush body conductively connected to the base plate, and free fiber ends of the fibrous brush body configured to conform to a shape of a substrate contacted by the brush.

2. The brush according to claim 1, wherein the base plate is mechanically conductively attached to a conductor comprising multiple current flow barriers oriented parallel to the at least one electrically insulating current flow barrier.

3. The brush according to claim 1, further comprising:
a substrate comprising multiple current flow barriers oriented parallel to the at least one electrically insulating current flow barrier.

4. The brush according to claim 1, wherein the current flow barrier has a thickness less than a thickness of at least one of the conductive portions.

5. A monolithic brush for suppressing circulatory currents, comprising:
a base plate comprising plural conductive portions separated by at least one electrically insulating current flow barrier, the at least one current flow barrier oriented normal to the plane of an expected circulatory current; and
a monolithic brush body comprising multiple conductive, substantially parallel portions that oriented normal to a plane of an expected circulatory current, the multiple conductive, substantially parallel portions separated by at least one electrically insulating current flow barrier, the monolithic brush body conductively connected to the base plate, and one free surface of the fibrous brush body configured to conform to a shape of a substrate contacted by the brush.

6. The brush according to claim 5, wherein the base plate is mechanically conductively attached to a conductor comprising multiple current flow barriers oriented parallel to the at least one electrically insulating current flow barrier.

7. The brush according to claim 5, further comprising:
a substrate comprising multiple current flow barriers oriented parallel to the at least one electrically insulating current flow barrier.

8. The brush according to claim 5, wherein the current flow barrier has a thickness less than a thickness of at least one of the conductive portions.

9. A metal fiber brush for suppressing circulatory currents, comprising:
a base portion comprising plural conductive portions separated by plural grooves disposed in the base portion; and
an insulative material disposed in the grooves.

10. The brush according to claim 9, wherein the insulative material comprising at least one of an epoxy, a glue, a ceramic cement and a rubber.

11. A method of manufacturing a brush, comprising:
disposing an insulative portion between two conductive portions to form a base plate with current flow barriers configured to suppress circulatory current loops that are disposed normal to the current flow barriers; and
attaching multiple conductive fibers with electrically insulating surfaces to the base plate.

12. The method according to claim 11, wherein the multiple conductive fibers with electrically insulated surfaces are attached to the base portion after disposing the current flow barriers between the conductive portions.

13. The method according to claim 11, wherein the multiple conductive fibers with electrically insulated surfaces are attached to the base portion before disposing current flow barriers between the conductive portions.

14. The method according to claim 11, further comprising:
forming the base plate into a size suitable for installation in an electrical machine after disposing the current flow barriers between the conductive portions and attaching the multiple conductive fibers with electrically insulated surfaces.

15. A brush configured to suppress circulatory currents, comprising:
first and second means for conducting a current;
means for preventing conduction of a current, the means for preventing disposed between the first and second means for conducting; and
means for electrically connecting the first and second means for conducting with a substrate.

16. The brush according to claim 15, wherein the first and second means for conducting and the means for preventing conduction form a base plate.

17. The brush according to claim 16, wherein the means for electrically connecting comprises a brush body.

18. The brush according to claim 17, wherein the brush body comprises a monolithic brush body.

19. The brush according to claim 17, wherein the brush body comprises a fibrous brush body.

20. The brush according to claim 15, wherein the means for preventing conduction are oriented to impede circulatory currents from being conducted between the first and second means for conducting.
